(19) United States
(12) Patent Application Publication
(10) Pub. No.: US 2022/0109510 A1
(43) Pub. Date: Apr. 7, 2022

(54) Optical Data Interconnect System

(71) Applicant: WINGCOMM Co, Ltd., Nantong (CN)

(72) Inventors: Yun Bai, Beijing (CN); Wei Mao, Palo Alto, CA (US); Zuodong Wang, Beijing (CN); Jianming Yu, Nantong (CN)

(21) Appl. No.: 17/553,468

(22) Filed: Dec. 16, 2021

Related U.S. Application Data
(63) Continuation-in-part of application No. 16/817,310, filed on Mar. 12, 2020, now Pat. No. 11,233,570.
(60) Provisional application No. 62/817,279, filed on Mar. 12, 2019.

(51) Int. Cl. H04B 10/80; H04B 10/27; H04B 10/50; H04B 10/40

(52) U.S. Cl. CPC H04B 10/808; H04B 10/40; H04B 10/503; H04B 10/27

(57) ABSTRACT

Systems and methods related to battery triggering for activation of an optical data interconnect system are described. One aspect includes signal conversion electronics configured to convert received optical signals to an electrical signal. An amplifier may convert the electrical signal to differential electrical signals and transmit the differential electrical signals to a sink. A first conductor and a second conductor may interface the amplifier with a sink side resistor network. The first conductor and the second conductor may conduct a composite signal including the differential electrical signals and a first power signal from the sink side resistor network. A filter connected to the first conductor and the second conductor may be configured to receive the composite signal, and filter a second power signal from the composite signal that is at least a portion of the first power signal. A voltage regulator may connect the second power signal to the amplifier.

### CROSS-REFERENCE TO RELATED APPLICATIONS

This application is a continuation-in-part of U.S. patent application Ser. No. 16/817,310, filed Mar. 12, 2020, titled “Sink Powered Optical Data Interconnect System” which is incorporated herein by reference in its entirety.

That application claims priority to U.S. Provisional Patent Application Ser. No. 62/817,279, filed Mar. 12, 2019, titled “Target Powered Optical Data Interconnect System” which is incorporated herein by reference in its entirety, including but not limited to those portions that specifically appear hereinafter, the incorporation by reference being made with the following exception: In the event that any portion of the above-referenced application is inconsistent with this application, this application supersedes the above-referenced application.

### TECHNICAL FIELD

The present disclosure relates to system for optical interconnect. In particular, a system and method for emulating electrical HDMI interconnects with an optical system is described.

### BACKGROUND

High Definition (HD) signals are typically transmitted from one system to another using cables carrying DVI (Digital Video Interface) or HDMI (High Definition Multimedia Interface) signals. Conventionally, DVI/HDMI signals are conveyed over copper cables using a form of differential signaling called Transition Minimized Differential Signaling (TMDS). In TMDS, video, audio, and control data can be carried on three TMDS data channels with a separate TMDS channel for clock information. Recently HDMI 2.1 introduced another differential signaling form called Fixed Rate Link (FRL) to replace TMDS for delivering higher uncompressed resolutions such as 8K60 Hz. Unfortunately, over long distances of (e.g. 5 meters or greater) the impedance of copper cable can cause a large signal loss resulting in artifacts such as pixelation, optical flashing or sparkling, or even loss of picture. These artifacts can be reduced by passive connection designs involved large or well shielded copper cables, but this is costly, bulky, and limits cable flexibility. Alternatively, active electronic modules such as signal boosters can be used to reduce signal loss, but these techniques are also costly and can result in introduction of signal errors.

### SUMMARY

One embodiment includes signal conversion electronics configured to convert received optical signals to an electrical signal. An amplifier may be configured to convert the electrical signal to differential electrical signals and transmit the differential electrical signals to a sink.

In one aspect, A first conductor and a second conductor interface the amplifier with a sink side resistor network. The first conductor and the second conductor may conduct a composite signal including the differential electrical signals and a first power signal from the sink side resistor network.

A filter connected to the first conductor and the second conductor may be configured to receive the composite signal, and filter a second power signal from the composite signal that is at least a portion of the first power signal. A voltage regulator may connect the second power signal to the amplifier.

Some embodiments may include methods to implement the above apparatus embodiment.

### BRIEF DESCRIPTION OF THE DRAWINGS

Non-limiting and non-exhaustive embodiments of the present disclosure are described with reference to the following figures, wherein like reference numerals refer to like parts throughout the various figures unless otherwise specified.

FIG. 1 illustrates an optical interconnect system;

FIG. 2 illustrates a method of operating an optical interconnect system;

FIG. 3 illustrates an optical interconnect system with external power; and

FIG. 4 illustrates a bi-directional optical interconnect system.

FIG. 5A illustrates one embodiment of an optical interconnect system that converts HDMI standard TMDS or FRL signals to optical signals and includes a rechargeable battery;

FIG. 5B illustrates one embodiment of an optical interconnect system that converts HDMI standard TMDS or FRL signals to optical signals that includes a power tapping circuit without a battery;

FIG. 5C illustrates one embodiment of an optical interconnect system that converts control or other signals to optical signals;

FIG. 6A illustrates all optical connections for data and control connections for an HDMI compatible interconnect;

FIG. 6B illustrates optical data connections, electrical control connections, and an electrical power connection for an HDMI compatible interconnect;

FIG. 6C illustrates all optical data and control connections and an electrical power connection for an HDMI compatible interconnect; and

FIG. 7 illustrates one embodiment of an HDMI connector according to the disclosure.

FIG. 8 illustrates one embodiment of an optical interconnect system.

FIG. 9 illustrates one embodiment of an HDMI optical receiver interface.

FIG. 10 illustrates one embodiment of an HDMI optical receiver interface.

FIG. 11 is a flow diagram illustrating an embodiment of a method to connect a power signal.

### DETAILED DESCRIPTION

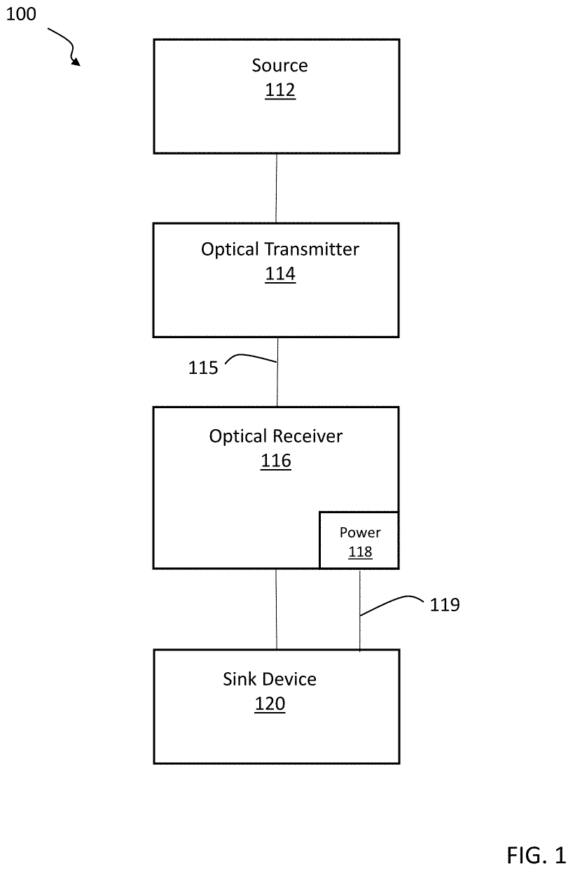

As seen in FIG. 1, an optical interconnect system 100 capable of supporting conversion of electrical signals to optical signals, and back to electrical signals is illustrated. A signal source 112 is connected to an optical transmitter 114 that acts as a first signal converter to convert electrical signals received from the signal source 112 into optical signals. One or more optical fibers 115 are used to transfer optically encoded data to an optical receiver 116. The optical receiver decodes and acts as a second signal converter to convert the data to electrical signals that are provided to a sink device 120. The optical receiver 116 can include a separate power module 118, which in at least one embodiment is connected via electrical power connection 119 to the sink device.

Various signaling protocols are supported by the optical interconnect system. In some embodiments, electrical signals can be provided in a first protocol by source 112 and converted to a second protocol by the optical receiver 116. In other embodiments, electrical signals can be provided in a first protocol by source 112 and converted back to the same protocol by the optical receiver 116.

In one particular embodiment, HDMI 1.4b/1.4, HDMI 2.0b/2.0, HDMI 2.1, or other suitable HDMI protocols can be supported. HDMI 1.4b/1.4 supports 4K (3840×2160 pixels) video at 30 frames per second, while HDMI 2.0b/2.0 supports 4K video at 60 frames per second, with a bit rate of up to 18 Gbps. The latest HDMI 2.1 supports 8K video at 60 frames per second and 4K video at 120 frames per second, with a bit rate of up to 48 Gbps. HDMI is based on HDMI standard TMDS or FRL serial links for transmitting video and audio data. Typically, the HDMI interface is provided for transmitting digital television audiovisual signals from DVD players, game consoles, set-top boxes and other audiovisual source devices to other HDMI compatible devices, such as television sets, displays, projectors and other audiovisual devices. HDMI can also carry control and status information in both directions.

In other embodiments, other connectors and protocols can be supported, including but not limited to serial or parallel connectors, Digital Video Interface (DVI), other suitable connectors such as those based on LVDS, DisplayPort, USB-C or SATA In some embodiments, alternative encoding systems can be used. For example, TMDS serial links can be replaced with low density parity check (LDPC) code for video data. Alternatively, or in addition, a variable length and rate Reed-Solomon (RS) code can be used for audio and control information to provide error protection. Advantageously, such codes require no additional overhead for DC-balancing or transition minimization, resulting in an increased data rate as compared to TMDS encoded signals.

In one embodiment, source 112 can include, for example, DVD players, game consoles, smartphones, set-top boxes, telephones, computers, audio systems, or other network client devices. Source 112 can playback media data stored in a hard drive, a spinnable disk (e.g. Blu-ray or DVD), or held in solid state storage. In other embodiments, the source 112 can receive data through wired or wireless connection to cable providers, satellite systems, or phone networks. Similarly, sink device 120 can also be televisions, monitors, displays, audio systems, projectors, or other network client devices.

In one embodiment, the optical transmitter 114 can convert HDMI standard TMDS or FRL electrical signals using an optical conversion device connected to ground to reduce noise. Typically, this can be a laser diode driver (LDD). The optical conversion driver device can include an infrared or optical LED, semiconductor laser, or VCSEL device.

Advantageously, use of optical fiber 115 and elimination of electrical wired connection both provides electrical isolation and greatly improved signal. The optical fiber 115 is well suited for using consumer or household environments, as well as in electrically active, wet, or moist environments such as are found in industrial, manufacturing, automobile, trucking, shipping, and avionics. In one embodiment, the optical fiber 115 includes one or more multi-mode optical fibers protected by braided fiber or plastic sheathing or other suitable covering. If complete electrical isolation is not required, in another embodiment one or more low voltage electrical wires are also supported to provide power or control signals.

In one embodiment, the optical receiver 116 can convert optical signals to HDMI standard TMDS or FRL or other suitable electrical signals. The optical receiver 116 can include a photo detector and an optical receiver that convert light impulses to an electrical signal. In some embodiments, a transimpedance amplifier (TIA) or other suitable signal amplification system can be used to increase signal power, and a PD (photodiode) or an APD (avalanche photodiode) can be used to convert optical signals to electrical currents.

Power from power module 118 to operate the optical receiver 116 can be provided by connection to the sink device 120, by connection to a second power port or another external power source (not shown), or by an internal battery source. In some embodiments, a sink device can support multiple connector types (HDMI, DisplayPort, USB, USB-C, DC power connector) that can be used as external secondary power sources and/or internal battery charging stations. In those embodiments that support source HDMI to sink HDMI connections, both power to operate optical receiver 116 and additional power to emulate an electrical HDMI connection can be required since conventional HDMI connectable devices require a DC connection between the source 112 and a grounded sink device 120 to complete the circuit. This DC connection creates a current return path from the sink device 120 to the source 112. Since this connection is typically provided through internal shields covering the individual twisted wire pairs and a covering braid shield that are not available in a dedicated optical interconnect system, an additional power source is needed.

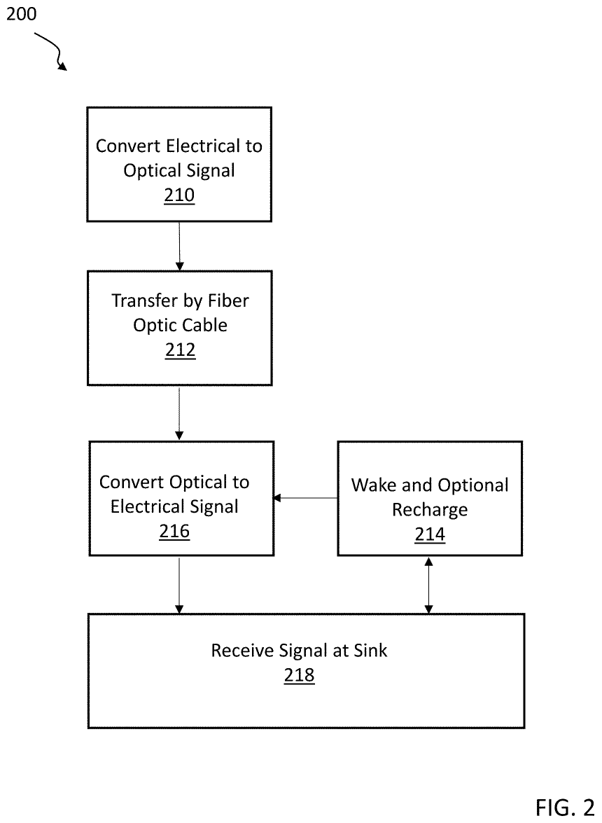

FIG. 2 illustrates a method 200 for interconnecting a source and a sink. Electrical signals from the source are converted to an optical signal (step 210) using a driver device for an infrared or optical LED, semiconductor laser, or VCSEL device. The optical signal is injected into a fiber optic cable and transferred (step 212). The transferred optical system is converted to an electrical signal (step 216) that is received by a sink (step 218). In order to ensure conversion of the electrical signal, plugging into the sink or connection to another external power source can supply power, wake signal conversion microprocessors or other electronics, and charge optional batteries (step 214).

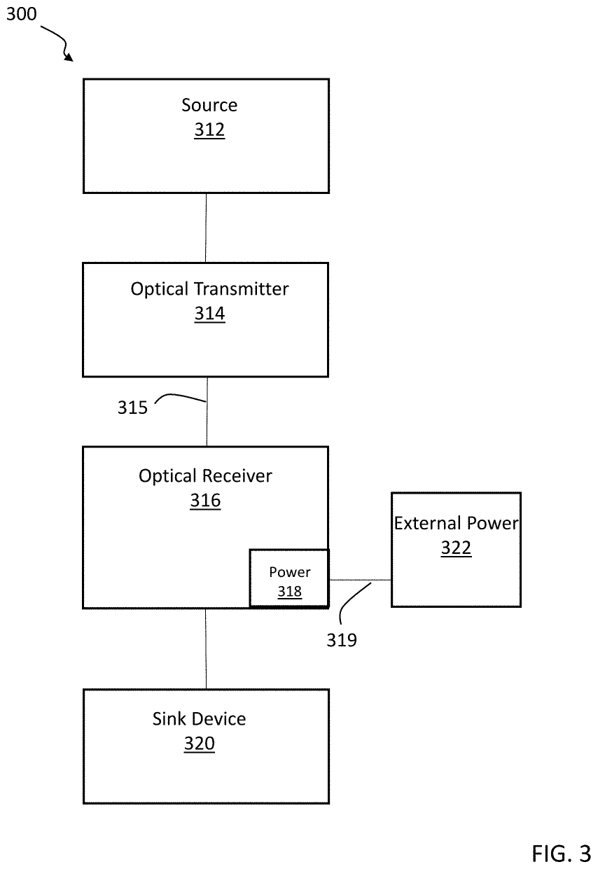

FIG. 3 illustrates an optical interconnect system with external power. In this embodiment a signal source 312 is connected to an optical transmitter 314 that converts electrical signals received from the signal source 312. One or more optical fibers 315 are used to transfer optically encoded data to an optical receiver 316. The optical receiver decodes and converts the data to electrical signals that are provided to a sink device 320. The optical receiver 316 can include a separate power module 318, which in at least one embodiment is provided by electrical power connection 319 to an external power module 322. In some embodiments the power module can be provided via other ports or power supplies on the sink device (e.g. a USB port), while in other embodiments power can be supplied by another device (e.g. a power over ethernet connection from a network switch) or a suitable direct power supply.

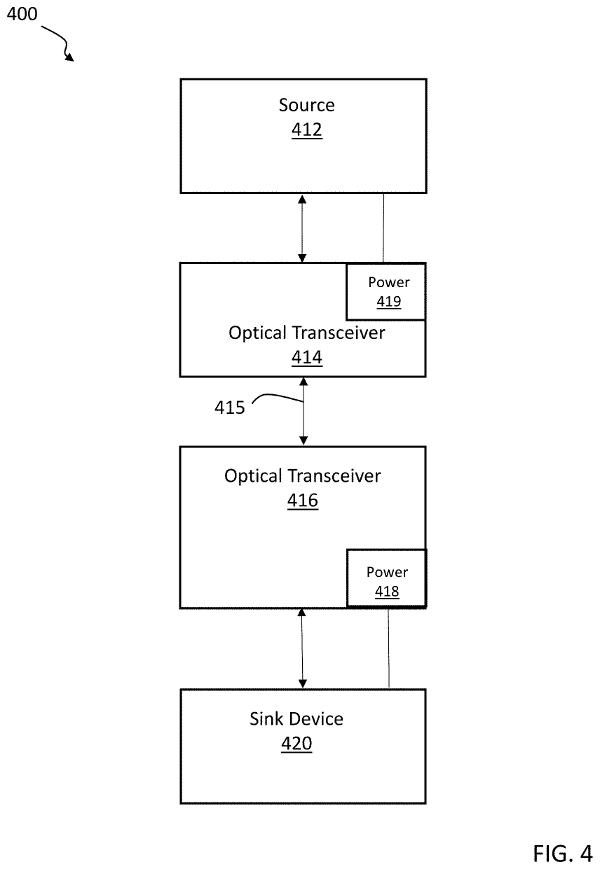

FIG. 4 illustrates a bi-directional optical interconnect system 400 capable of supporting conversion of electrical signals to optical signals, and back to electrical signals. In a first direction of data transfer, signal source 412 is connected to an optical transceiver 414 that converts electrical signals received from the signal source 412. One or more optical fibers 415 are used to transfer optically encoded data to an optical transceiver 416. The optical transceiver 416 decodes and converts the data to electrical signals that are provided to a sink device 420. A return signal from the sink device 420 to source 412 is also supported.

Both the optical transceiver 414 and 416 can include a respective separate power module 419 and 418. In at least one embodiment an electrical power connection can be made from power module 418 to the sink device 420. Similarly, an electrical power connection can be made to the source device 412 from the power module 419.

In one embodiment optical fiber can used for data transmission from the source device to the sink device. Additional optical fiber can be used for the transmission of a return signal from the sink device 420 to the source device 412. Such bi-directional signal functionality allows fuller support of the HDMI specification, including channels supporting low data-rate remote control commands, audio return from sink device to source, ethernet communication, and hot plug detection. Such data channels can include, but not limited to, a Consumer Electronics Control (CEC), an Audio Return Channel (ARC) or Enhanced Audio Return Channel (eARC), a HDMI Ethernet Channel (HEC) and a Hot Plug Detect (HPD). CEC allows a user to use a single remote to control multiple devices coupled together via HDMI cables. More specifically, a unique address is assigned to the connected group of devices, which is used for sending remote control commands to the devices.ARC or eARC is an audio link meant to replace other cables between sink device and source that allows source to reproduce the audio output from the sink device without using other cables. HEC enables IP-based applications over HDMI and provides a bidirectional Ethernet communication. HPD allows the source to sense the presence of sink device and reinitiates link if necessary.

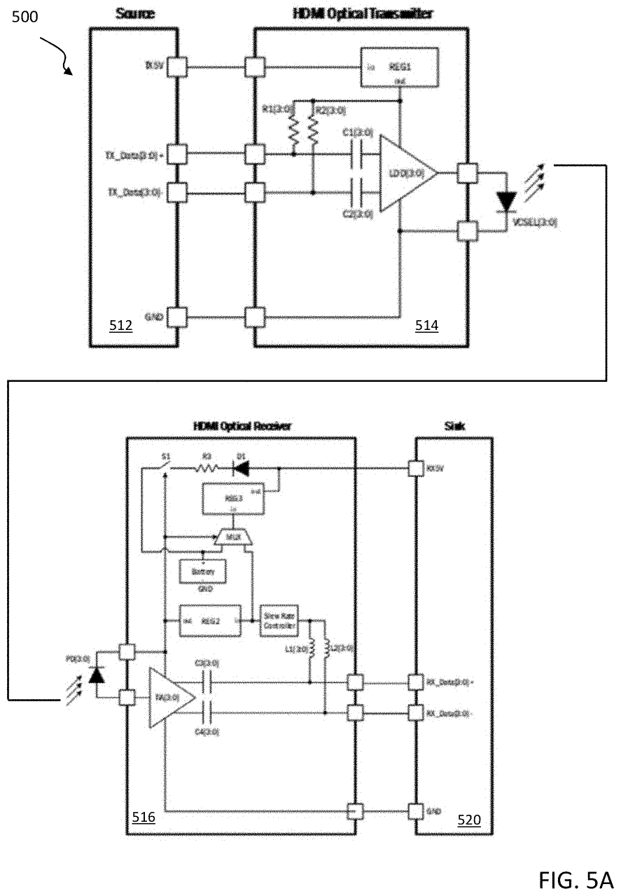

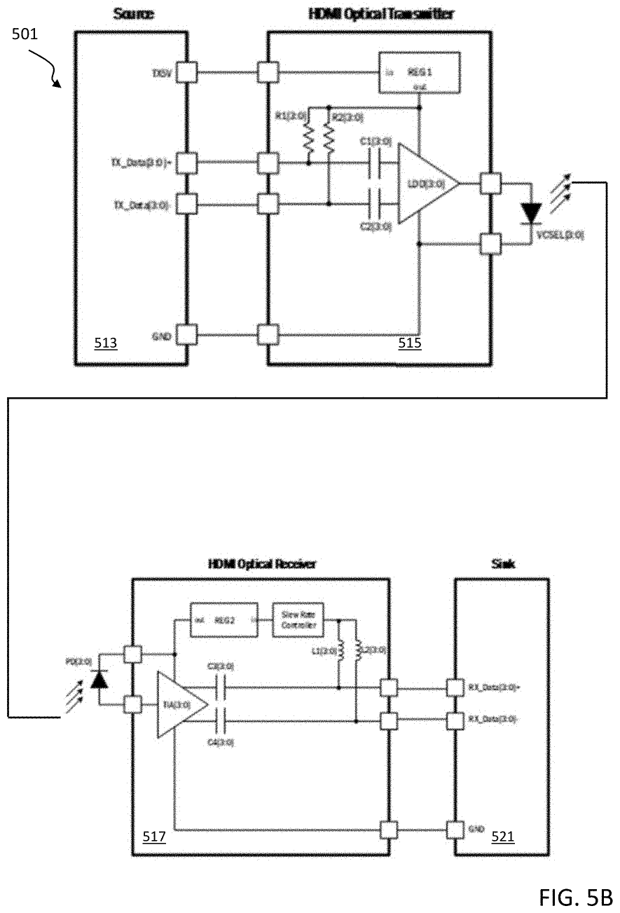

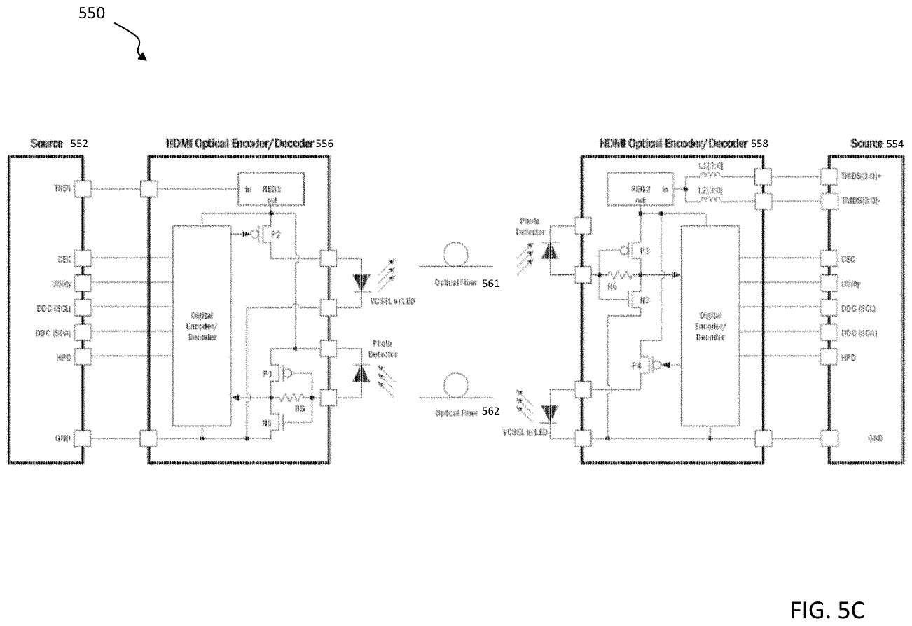

FIG. 5A illustrates one embodiment of HDMI optical fiber data connection system 500 that includes electrical to optical, and subsequent optical to electrical conversion. This embodiment can substantially replace a conventional electrical HDMI interface having two identical connectors attached to opposite ends of a cable. Such cables typically include four shielded twisted pairs of copper wires and seven separate copper wires for communicating various information. Four of the shielded twisted wire pairs are adapted to communicate relatively high-speed data and clock in the form of Transition Minimized Differential Signaling (HDMI standard TMDS or FRL). In HDMI 2.0b and previous HDMI standards, three pairs are used for communicating video, audio, and auxiliary data, and are typically referred to as D0-D2. The last pair is used for transmitting a clock associated with the data, and is typically referred to as CLK. In HDMI 2.1, all four pairs are used for communicating video, audio and auxiliary data, and are typically referred to as D0-D3. The speed of the high-speed data may range from 3 to 12 gigabits per second (Gbps) per lane. The remaining seven separate wires are used for communicating relatively low-speed data, such as in the range of 100 kilobits per second (kbit/s) to 400 kbit/s. Two of such wires are referred to as Display Data Channel (DDC) for providing communication between devices using a communication channel that adheres to an I²C bus specification. One of the DDC wire pair, typically referred to as DDC DATA, is used to communicate data between the devices. The other DDC wire pair, typically referred to as DDC CLK, is used to transmit a clock associated with the data. The other five of the seven separate wires are CEC, utility, HPD, 5V power and ground.

In operation, the respective HDMI standard TMDS or FRL, DDC, and other electrical signals from source 512 are provided to a transmitter 514 housed in an HDMI compatible connector. Using a laser diode driver (LDD) and a semiconductor laser or LED diode powered by voltage regulator REG1, an optical signal is generated and transferred to a photodetector and HDMI standard TMDS or FRL receiver 516 housed in another HDMI compatible connector. The HDMI standard TMDS or FRL receiver includes a transimpedance amplifier (TIA) connected to amplify the photodetector signal. The amplified electrical signals corresponding to the originally provided HDMI standard TMDS or FRL, DDC, and other electrical signals are sent to a television, display, or other suitable sink 520.

In one embodiment, electrical power is supplied to the HDMI standard TMDS or FRL receiver through an electrical tap of the HDMI standard TMDS or FRL port by inductors L1 and L2 (or other suitable electrical filtering circuit element such as ferrite beads) connected to a voltage regulator (REG2). The voltage regulator REG2 is connected to ground to reduce noise and acts to convert the voltage to the required operating voltage or voltages for a transimpedance amplifier that receives optical signals and converts them to electrical signals.

In some commercially available embodiments however, this mechanism will not work unassisted, since application of a specific voltage power is required to enable or otherwise trigger provision of power to the HDMI connection and connected electronics from sink 520.

For embodiments that require power triggering of the HDMI connection, a rechargeable battery, supercapacitor, or similar charge bank can be used to supply an initial 5-volt charge via regulator (REG3) to the 5V pin on the HDMI port (RX5V) of the sink 520. After triggering activation of the HDMI port, the electrical tap by inductors L1 and L2 (or other suitable electrical filtering circuit element such as ferrite beads) can be used to charge the battery or other power source. In operation, when the HDMI connector is not plugged into the sink 520, an enable pin “en” of REG3 is kept as open circuit and pulled to ground by resistor R4. Therefore, REG3 is turned off and thus does not draw current from the battery. When the HDMI connector is plugged into the sink 520 (e.g. a TV or display), the CEC pin or other appropriate pins, such as DDC, is connected to REG3 “en”, which has certain voltage, e.g. 3.3V. REG3 is turned on and up-converts the battery voltage, e.g. 1.5V, to 5V. When the “5V” pin of the sink 520 is pulled to 5V, it starts to power the HDMI standard TMDS or FRL+ and HDMI standard TMDS or FRL− ports. Inductors L1 and L2 block the AC signal provided by HDMI standard TMDS or FRL data connections and pass through the DC voltage (e.g. 2V) from HDMI standard TMDS or FRL ports to REG2 “in”. REG2 up-converts or down-converts this voltage to the necessary voltage or voltages for the TIA to operate. Once REG2 starts to output a voltage, it switches the MUX input so that REG3 “in” is connected to REG2 “in”. It also closes switch S1 and REG3 “out” starts to charge the battery.

Effectively, operation of the described circuit allows for the rechargeable battery supplying power to the 5V pin on the HDMI port of the sink 520 (RX5V) to be controlled to prevent battery dissipation when HDMI connector is unplugged. The rechargeable battery only operates when the cable is first plugged into the sink 520. After the sink 520 starts to power the HDMI standard TMDS or FRL ports, the rechargeable battery stops output current and instead is switched into a recharge mode.

Alternatively, FIG. 5B illustrates one embodiment of an optical interconnect system 501 similar to that discussed with respect to FIG. 5A that converts HDMI standard TMDS or FRL signals to optical signals that includes a power tapping circuit without a battery. In operation, the respective HDMI standard TMDS or FRL, DDC, and other electrical signals from source 513 are provided to a transmitter 515 housed in an HDMI compatible connector. Using a laser diode driver (LDD) and a semiconductor laser or LED diode powered by voltage regulator REG1, an optical signal is generated and transferred to a photodetector and HDMI standard TMDS or FRL receiver 517 housed in another HDMI compatible connector. The HDMI standard TMDS or FRL receiver includes a transimpedance amplifier (TIA) connected to amplify the photodetector signal. The amplified electrical signals corresponding to the originally provided HDMI standard TMDS or FRL, DDC, and other electrical signals are sent to a television, display, or other suitable sink 521. In addition, the described circuit includes a slew rate controller to control ramp up time of current draw of REG2 from the power taps on the high speed differential signal RX Data[3:0]. If this ramp up time is too short, the DC voltage on RX Data[3:0] can drop to such a low level that REG2 stops working. This is prevented by the slew rate controller regulating the ramp up time to be slow enough to ensure the proper power tapping on RX Data[3:0].

FIG. 5C illustrates one embodiment of an optical interconnect system 550 that converts both HDMI standard TMDS or FRL and control or other non-HDMI standard TMDS or FRL signals to optical signals. HDMI protocol requires bi-directional communication channels between source 552 and sink 554 for successful video/audio transmission and reception, which include but not limited to CEC, Utility, DDC (SCL), DDC (SDA), Ground, 5V Power and HPD. In the embodiment of FIG. 5B, all communication channels between source 552 and sink 554 are aggregated onto two optical fibers. An optical fiber 561 carries data from source 552 to sink 554, while an optical fiber 562 carries data from sink 554 to source 552, thus establishing bidirectional communication. Digital signal processing are realized by Digital Encoder/Decoder 1 (DED1 556) on the source side and Digital Encoder/Decoder 2 (DED 558) on the sink side. DED1 556 and 558 can either combine multiple communication channels into single aggregated channel or separate single aggregated channel into multiple communication channels. As illustrated, P2 is a current source that is powered by REG1 “out” and modulated by DED1 and drives a VCSEL or LED diode. REG1 in FIG. 5B operates in a manner similar to REG 1 as seen in FIG. 5A. P1, N1 and R5 form a transimpedance amplifier that is powered by REG1 “out” and buffers a photodetector's output into DED1. Similarly, P4 is a current source that is powered by REG2 “out” and modulated by DED2 and drives a VCSEL or LED diode. REG2 in FIG. 5B operates in a manner similar to REG2 as seen in FIG. 5A that utilizes inductive power tapping from the HDMI standard TMDS or FRL ports. P3, N3 and R6 form a transimpedance amplifier that is powered by REG2 “out” and buffers a photodetector's output into DED2. In this embodiment, multiple HDMI communication channels are replicated on both source and sink sides using only two optical fibers.

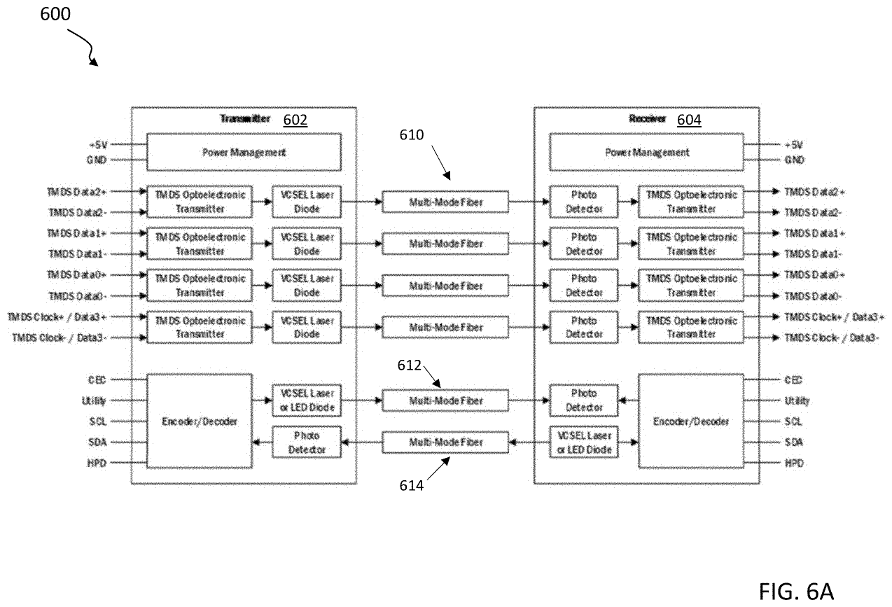

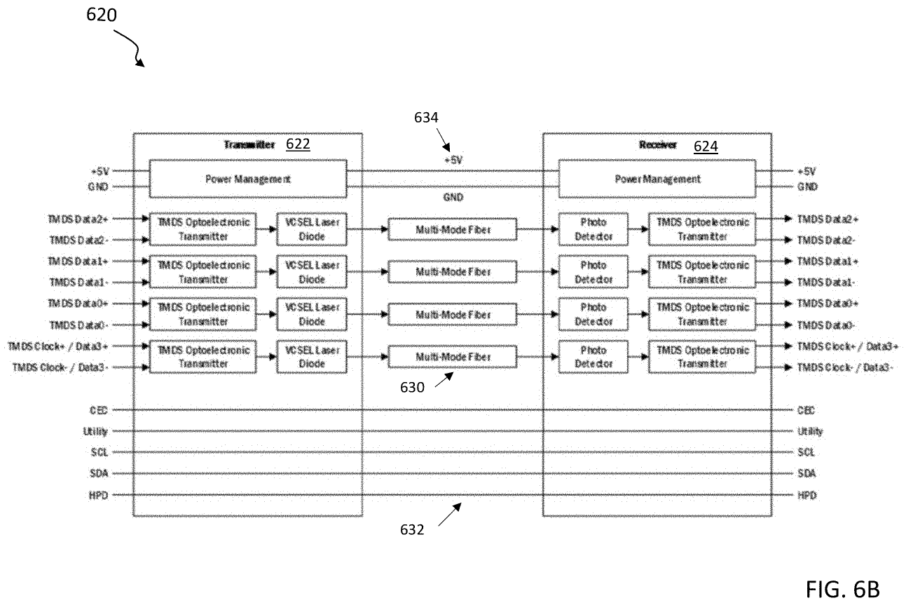

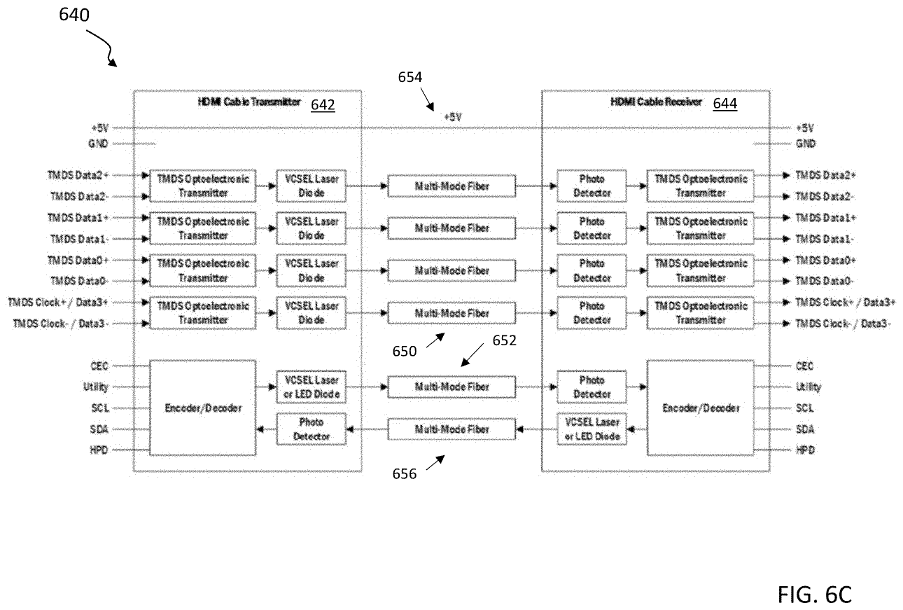

FIG. 6A illustrates one embodiment of a HDMI compatible fully optical interconnect system 600. As illustrated, multiple multi-mode optical fiber cables 610 and 612 are used to transmit data from a transmitter 602 to a receiver 604, and at least one multi-mode optical fiber 614 that transmits signals back from the receiver 604 to the transmitter 602. In the transmitter 602, electrical HDMI standard TMDS or FRL and non-HDMI standard TMDS or FRL data are converted to optical pulses using VCSEL laser or LED diodes. A photodetector and associated circuits are used to convert received optical pulses from optical fiber 614 to electrical signals that can be processed by a connected source (not shown). The receiver 604 has multiple photodetectors and respectively connected HDMI standard TMDS or FRL optoelectronic transmitters to convert received optical pulses from optical fiber 610 and 612 to electrical signals that can be processed by a connected sink (not shown). The receiver 604 also includes a VCSEL laser or LED diode connected to an encoder/decoder to convert electrical signals to optical signals that can be sent to the transmitter 602.

FIG. 6B illustrates one embodiment of a HDMI compatible hybrid electrical and optical interconnect system 620. As illustrated, multiple multi-mode optical fiber cables 630 are used to transmit data from a transmitter 622 to a receiver 624. In the transmitter 622, electrical HDMI standard TMDS or FRL data is converted to optical pulses using VCSEL laser or other laser diodes. A photodetector and associated circuits are used to convert received optical pulses from optical fiber 634 to electrical signals that can be processed by a connected source (not shown). The receiver 624 has multiple photodetectors and respectively connected HDMI standard TMDS or FRL optoelectronic transmitters to convert received optical pulses from optical fiber 630 to electrical signals that can be processed by a connected sink (not shown). In addition to the optical connections, the system 620 also supports electrical wired connection 632 for various control and data signals. As will be understood, these connections can be unidirectional or bidirectional between transmitter 622 and receiver 624. In addition, the system includes an electrical power connection 634 connecting respective power management units of transmitter 622 and receiver 624. Advantageously, because power is available, power triggering of the HDMI connection and their associated electronics and battery systems such as described with respect to the embodiment illustrated in FIG. 5 are not necessary.

FIG. 6C illustrates all optical data connections and an electrical power connection for an HDMI compatible interconnect system 640. As illustrated, multiple multi-mode optical fiber cables 650 and 652 are used to respectively transmit data and control data from a transmitter 642 to a receiver 644, and as well as at least one multi-mode optical fiber 656 that transmits signals back from the receiver 644 to the transmitter 642. In the transmitter 642, electrical HDMI standard TMDS or FRL data is converted to optical pulses using VCSEL laser or LED diodes. The receiver 644 has multiple photodetectors and respectively connected HDMI standard TMDS or FRL optoelectronic transmitters to convert received optical pulses from optical fiber 650 and 652 to electrical signals that can be processed by a connected sink (not shown). The receiver 644 also includes a VCSEL laser or LED diode connected to an encoder/decoder to convert electrical signals to optical signals that can be sent to the transmitter 642 along multi-mode optical fiber 656. In addition, the system includes an electrical power connection 654 connecting transmitter 642 and receiver 644. Advantageously, because power is available, power triggering of the HDMI connection and their associated electronics and battery systems such as described with respect to the embodiment illustrated in FIG. 5 are not necessary. However, in certain embodiments, a power tap on HDMI standard TMDS or FRL ports (e.g. using inductors and regulators) can still be used to power the HDMI standard TMDS or FRL receiver or other associated circuitry.

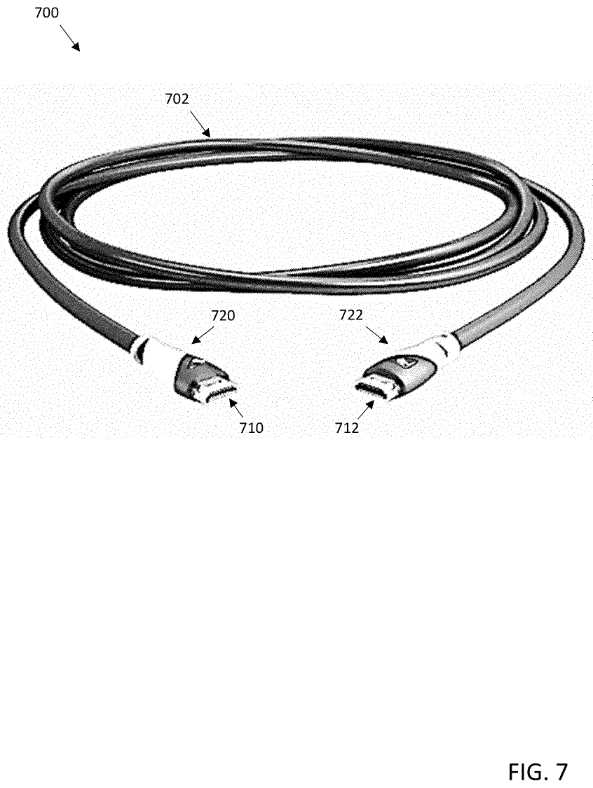

FIG. 7 illustrates one embodiment of a HDMI compatible interconnect system 700 including bundled and loosely looped optical cables 702, and source 710 and sink 712 HDMI connectors. Signal converters 720 and 722 include housing and board layout for HDMI standard TMDS or FRL receiver, as well as other electronics supporting electrical to optical conversion or optical to electrical conversion and are located adjacent to respective HDMI connector 710 and 712.

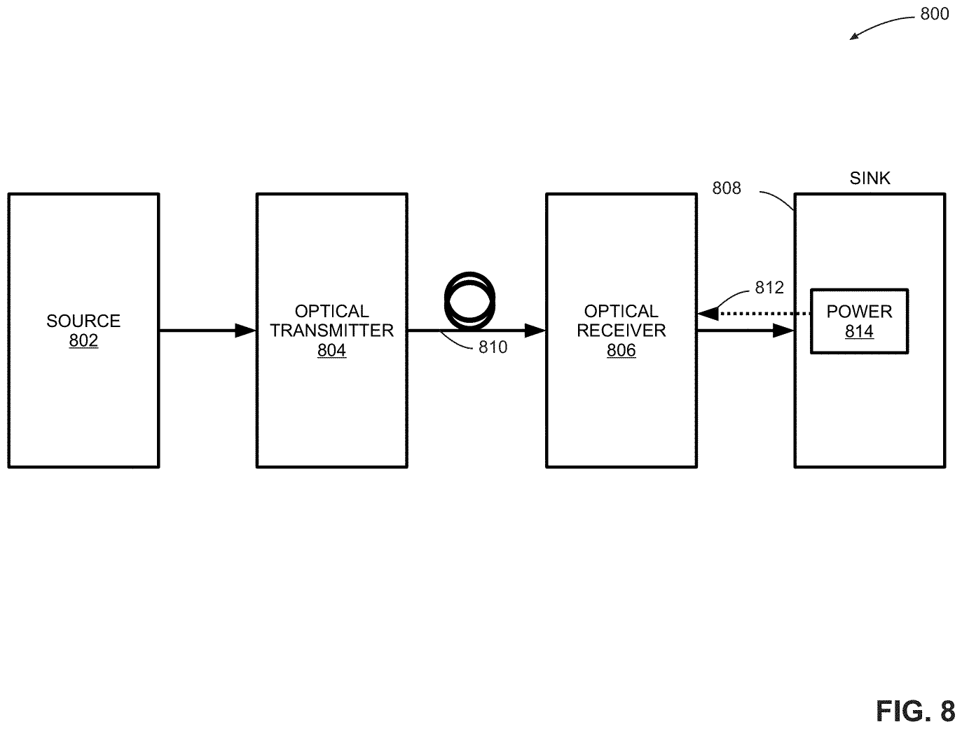

FIG. 8 illustrates one embodiment of an optical interconnect system 800. As depicted, optical interconnect system 800 includes a source 802, an optical transmitter 804 connected to an optical receiver 806 via an optical communication channel 810, and a sink 808. Sink 808 may further include a power module, depicted as power 814. In general, power 814 can be configured to supply electrical power to optical receiver 806.

Source 802 may be similar to source 112, optical transmitter 802 may be similar to optical transmitter 114, optical receiver 806 may be similar to optical receiver 116, sink 808 may be similar to sink 120, and optical communication channel 810 may be similar to optical fiber(s) 115.

Optical interconnect system 800 may be configured such that source 802 is connected to an optical transmitter 804 that acts as a first signal converter to convert electrical signals received from source 802 into optical signals. Source 802 may be a source of one or more HDMI electrical signals. Optical communication channel 810 used to transfer optically encoded data to optical receiver 806. Optical receiver 806 may act as a second signal converter to convert the data to electrical signals that are provided sink 808. In one aspect, power 814 is configured to supply electrical power to optical receiver 806.

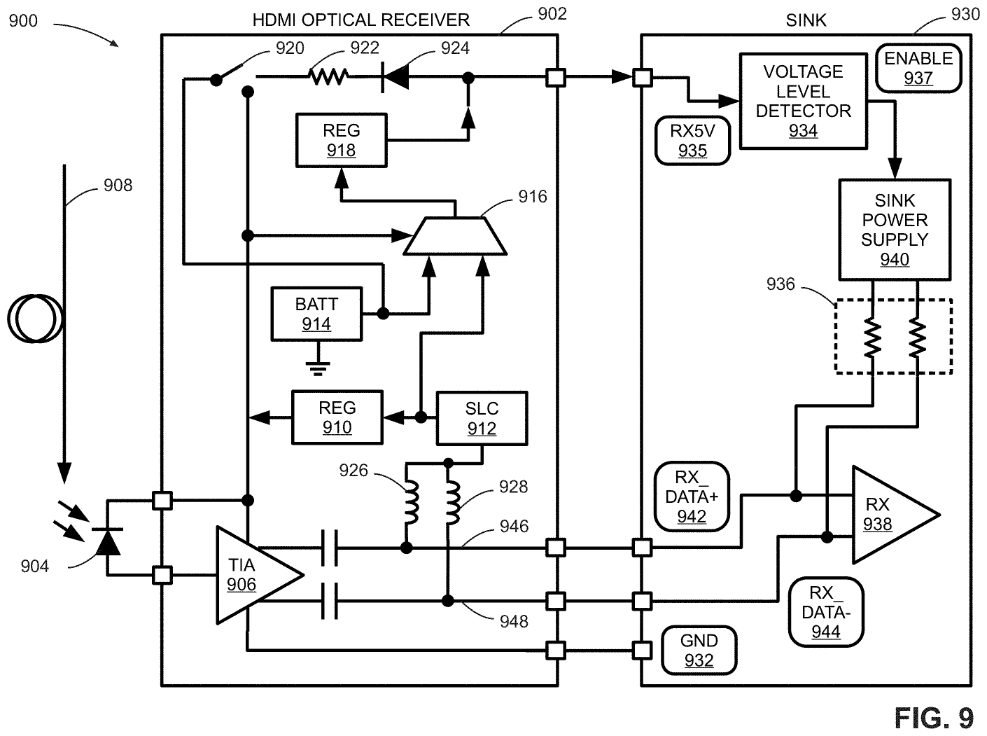

FIG. 9 illustrates one embodiment of an HDMI optical receiver interface 900. As depicted, HDMI optical receiver interface 900 includes an optical communication channel 908, an HDMI optical receiver 902, and a sink 930. HDMI optical receiver 902 further includes a photodetector 904, a transimpedance amplifier TIA 906, a regulator REG 910, a slew rate converter SLC 912, a battery BATT 914, a multiplexer 916 a regulator REG 918, a switch 920, a resistor 922, a diode 924, an inductor 926, an inductor 928, a conductor 946, and a conductor 948. Sink 930 further includes a voltage level detector 934, a sink power supply 940, a resistor network 936, and an amplifier RX 938.

As depicted HDMI optical receiver 902 and sink 930, may represent an internal structure of optical receiver 806 and sink 808, respectively. Optical communication channel 908 may correspond to optical communication channel 810. Sink power supply 940 may correspond to power 814.

Photodetector 904 may be implemented using a photodiode. In one aspect, photodetector 904 receives one or more HDMI optical signals via optical communication channel 908. These optical signals may be comprised of one or more optical HDMI signals. Photodetector 904 converts these optical signals into a corresponding set of electrical signals. These electrical signals are amplified and converted into a corresponding set of differential electrical signals by transimpedance amplifier 906. The differential electrical signals output by transimpedance amplifier 906 are RX_data+ 942 and RX_data− 944. These signals are received by amplifier 938 and processed according to the HDMI receiver protocol. A common electrical ground GND 932 is shared between HDMI optical receiver 902 and sink 930.

In one aspect, transimpedance amplifier 906 needs electrical power to perform any amplification operations. Power may be supplied to transimpedance amplifier 906 from sink power supply 940. To enable sink power supply 940, sink 930 may require a triggering signal RX5V 935 to be supplied from HDMI optical receiver 902. An example of such an HDMI sink device is a television manufactured by Samsung.

When HDMI optical receiver 902 and sink 930 are initially connected, RX5V 935 may be triggered via battery 914, via multiplexer 916. Switch 920 may be configured such that multiplexer 916 routes a 5V voltage from regulator 918, which can boost an output voltage of battery 914, to voltage level detector 934 as RX5V, via the appropriate connecting pins. At the same time, switch 920 can connect resistor 922 and diode 924 between an output of regulator 918 and a power input terminal of transimpedance amplifier 906, so that transimpedance amplifier 906 can be powered by battery 914.

When voltage level detector 934 detects the RX5V voltage 935, voltage level detector 934 may output an enable signal 937 that enables sink power supply 940. Sink power supply 940 may then output a (DC) power signal via resistor network 936. In one aspect, resistor 936 network may be a part of an open drain interface. The output power is routed via resistor network 936, to amplifier 938. Amplifier 938 is a part of the HDMI receiver signal chain, and enables HDMI signal reception by sink 930.

At the same time, the power signal output by resistor network 936 may be received by conductor 946 and 948. In one aspect, each of conductor 946 and 948 is an electrical conductor (e.g., a copper wire or a copper terminal). The power signal from conductor 946 and 948 may be received by inductor 928 and inductor 926, respectively. Since the power signal is a DC signal, each of inductor 926 and 928 behaves as a substantially zero-resistance conductor for the power signal. The power signal is transmitted from inductors 926 and 928 to slew rate controller 912. Slew rate controller 912 may be similar to any of the slew rate controllers depicted in FIGS. 5A and 5B. Slew rate controller 912 may be configured to limit a ramp-up rate of the power signal during a transient phase, when the power signal is initially transmitted from sink power supply 940 to HDMI optical receiver 902. Limiting the ramp-up rate of the power signal, for example, by slew rate controller 912, facilitates appropriate operation of sink 930 and mitigates the possibility of sink 930 entering a shut down or a non-working state.

In one aspect, an output of slew rate controller 912 is a power signal that is routed to regulator 910 and to multiplexer 916. Regulator 910 converts the power signal output by slew rate controller 912 to a power signal at a voltage appropriate to power transimpedance amplifier 906. In this way, transimpedance amplifier 906 is powered by a power signal sourced from sink power supply 940. In other words, the power supply distribution to transimpedance amplifier 906 may be switched to being powered from the power signal sourced from sink power supply 940, after initially being powered by a power signal sourced from battery 914. At the same time, switch 920 is switched so that the output of regulator 910 is also used to charge battery 914. Also, multiplexer 916 is switched such that output of slew rate controller 912 is routed as the RX5V signal 935. At the same time, switch 920 can connect resistor 922 and diode 924 between regulator 918 and battery 914, so that battery 914 can be recharged. The DC power signal output by regulator 910 may also be used to recharge battery 914 for a subsequent initial triggering operation (e.g., when HDMI optical receiver 902 and sink 930 are disconnected and reconnected).

Once transimpedance amplifier 906 is powered up, transimpedance amplifier 906 begins to output HDMI electrical differential signals (i.e., RX_data+ 942 and RX_data− 944 signals) that are transmitted via conductors 946 and 948 respectively, to amplifier 938. These signals are time-varying signals. Along with outputting signals RX_data+ 942 and RX_data− 944, conductors 946 and 948 simultaneously conduct the DC power signal generated by sink power supply 940. Therefore, based at least in part on the superposition principle, a composite time-varying signal is carried by conductors 946 and 948. This composite time-varying signal may be comprised of the HDMI electrical differential signals and the DC power signal. In one aspect, inductors 926 and 928 perform a low-pass filtering action on this composite time-varying signal to extract a substantially DC power signal from the time-varying signal. This substantially DC power signal may be transmitted to slew rate controller 912, and then to regulator 910 and to multiplexer 916. The substantially DC power signal may be used to power transimpedance amplifier 906 and routed through multiplexer 916 as RX5V signal 935.

When using battery 914 to power the transimpedance amplifier, the resistor 922 and diode 924 can further regulate a 5V output voltage of regulator 918 to a desired voltage level required by the transimpedance amplifier 906. When charging battery 914 through power tapping, resistor 920 and diode 924 can regulate the 5V output voltage of regulator 918 to a desired voltage level required by the battery 914.

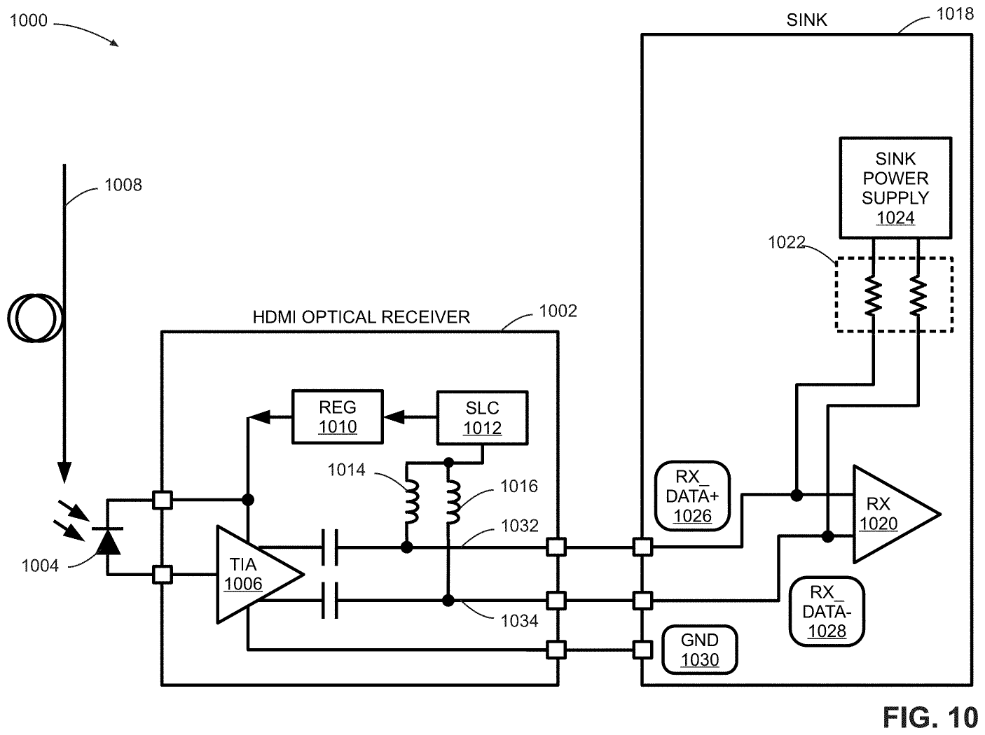

FIG. 10 illustrates one embodiment of an HDMI optical receiver interface 1000. As depicted, HDMI optical receiver interface 1000 includes an optical communication channel 1008, an HDMI optical receiver 1002, and a sink 1018. HDMI optical receiver 1002 further includes a photodetector 1004, a transimpedance amplifier TIA 1006, a regulator REG 1010, a slew rate converter SLC 1012, an inductor 1014, an inductor 1016, a conductor 1032, and a conductor 1034. Sink 1018 further includes a sink power supply 1024, a resistor network 1022, and an amplifier RX 1020.

As depicted HDMI optical receiver 1002 and sink 1018, may represent an internal structure of optical receiver 806 and sink 808, respectively. Optical communication channel 1008 may correspond to optical communication channel 810. Sink power supply 1024 may correspond to power 814.

Photodetector 1004 may be implemented using a photodiode. In one aspect, photodetector 1004 receives one or more HDMI optical signals via optical communication channel 1008. These optical signals may be comprised of one or more optical HDMI signals. Photodetector 1004 converts these optical signals into a corresponding set of electrical signals. These electrical signals are amplified and converted into a corresponding set of differential electrical signals by transimpedance amplifier 1006. The differential electrical signals output by transimpedance amplifier 1006 are RX_data+ 1026 and RX_data− 1028. These signals are received by amplifier 1020 and processed according to the HDMI receiver protocol. A common electrical ground GND 1030 is shared between HDMI optical receiver 1002 and sink 1018.

In one aspect, transimpedance amplifier 1006 needs electrical power to perform any amplification operations. Power may be supplied to transimpedance amplifier 1006 from sink power supply 1024. Sink power supply 1024 may output a (DC) power signal via resistor network 1022. In one aspect, resistor 1022 may be a part of an open drain interface. The output power is routed via resistor network 1022, to amplifier 1020. Amplifier 1020 is a part of the HDMI receiver signal chain, and enables HDMI signal reception by sink 1018.

At the same time, the power signal output by resistor network 1022 may be received by conductor 1032 and 1034. In one aspect, each of conductor 1032 and 1034 is an electrical conductor (e.g., a copper wire or a copper terminal). The power signal from conductor 1032 and 1034 may be received by inductor 1014 and inductor 1016, respectively. Since the power signal is a DC signal, each of inductor 1014 and 1016 behaves as a substantially zero-resistance conductor for the power signal. The power signal is transmitted from inductors 1014 and 1016 to slew rate controller 1012. Slew rate controller 1012 may be similar to any of the slew rate controllers depicted in FIGS. 5A and 5B. Slew rate controller 1012 may be configured to limit a ramp-up rate of the power signal during a transient phase, when the power signal is initially transmitted from sink power supply 1024 to HDMI optical receiver 1002. Limiting the ramp-up rate of the power signal, for example, by slew rate controller 1012, facilitates appropriate operation of sink 930 and mitigates the possibility of sink 1018 entering a shut down or a non-working state.

In one aspect, an output of slew rate controller 1012 is a power signal that is routed to regulator 1010. Regulator 1010 converts the power signal output by slew rate controller 1012 to a power signal at a voltage appropriate to power transimpedance amplifier 1006. In this way, transimpedance amplifier 1006 is powered by a power signal from sink power supply 940.

Once transimpedance amplifier 1006 is powered up, transimpedance amplifier 1006 begins to output HDMI electrical differential signals (i.e., RX_data+ 1026 and RX_data− 1028 signals) that are transmitted via conductors 1032 and 1034 respectively, to amplifier 1020. These signals are time-varying signals. Along with outputting signals RX_data+ 1026 and RX_data− 1028, conductors 1032 and 1034 simultaneously conduct the DC power signal generated by sink power supply 1024. Therefore, based at least in part on the superposition principle, a composite time-varying signal is carried by conductors 1032 and 1034. This composite time-varying signal may be comprised of the HDMI electrical differential signals and the DC power signal. In one aspect, inductors 1032 and 1034 perform a low-pass filtering action on this composite time-varying signal to extract a substantially DC power signal from the time-varying signal. This substantially DC power signal may be transmitted to slew rate controller 1012, and then to regulator 1010. The substantially DC power signal may be used to power transimpedance amplifier 1006.

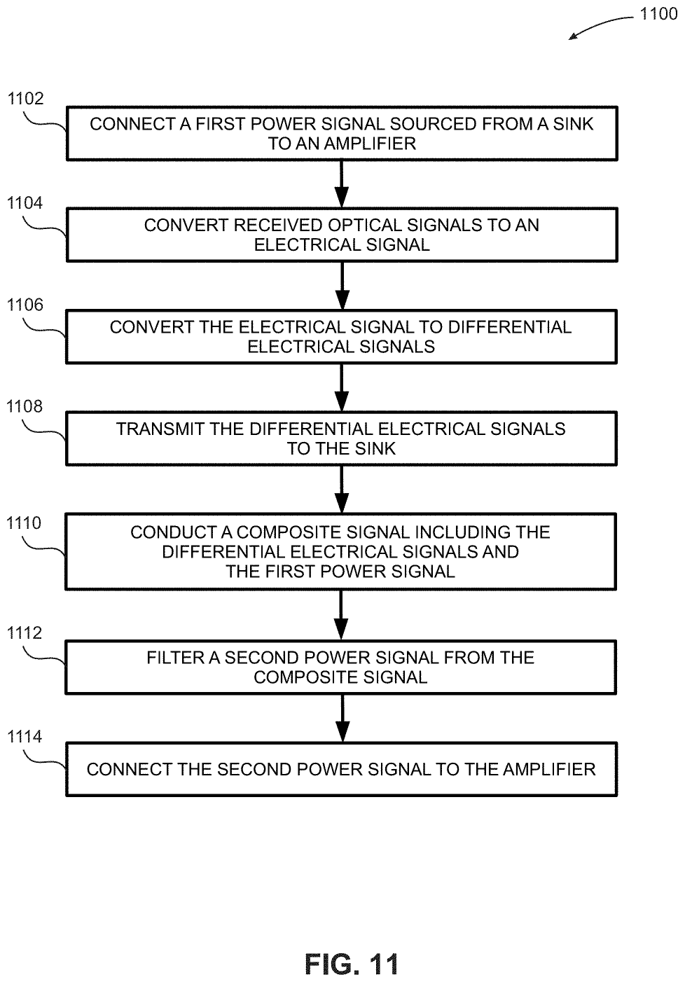

FIG. 11 is a flow diagram illustrating an embodiment of a method to connect a power signal 1100.

Method 1100 may include connecting a first power signal sourced from a sink to an amplifier (1102). For example, a DC power signal sourced from sink power supply 1024 may be routed to transimpedance amplifier 1006. This DC power signal may be routed to the amplifier via a combination of resistor network 1022, inductor 1014, and inductor 1016.

Method 1100 may include converting received optical signals to an electrical signal (1104). For example, photodetector 1004 may convert one or more optical HDMI signals received over optical communication channel 1008 to a corresponding set of one or more electrical signals.

Method 1100 may include converting the electrical signal to differential electrical signals (1106). For example, after being powered up, amplifier 1006 may convert each electrical signal received from photodetector 1004 to a pair of differential electrical signals—RX_data+ 1026 and RX_data− 1028.

Method 1100 may include transmitting the differential electrical signals to the sink (1108). For example, amplifier 1006 may transmit the differential electrical signals to amplifier 1020 via a combination of conductors 1032 and 1034. In one aspect, conductor 1032 conducts the RX_data+ 1026 signal, while conductor 1034 conducts the RX_data− 1028 signal.

Method 1100 may include conducting a composite signal including the differential electrical signals and the first power signal (1110). For example, based at least in part on superposition, conductors 1032 and 1034 may conduct a composite signal comprised of RX_data+ 1026 and RX_data− 1028 signals, and the DC power signal generated by sink power supply 1024.

Method 1100 may include filtering a second power signal from the composite signal (1112). For example, inductors 1014 and 1016 may filter out (i.e., extract) the substantially DC power signal from the composite signal via low-pass filtering.

Method 1100 may include connecting the second power signal to the amplifier (1114). For example, the substantially DC power signal may be routed to transimpedance amplifier 1006.

As will be understood, the system and methods described herein can operate for interaction with devices such as servers, desktop computers, laptops, tablets, game consoles, or smart phones. Data and control signals can be received, generated, or transported between varieties of external data sources, including wireless networks, personal area networks, cellular networks, the Internet, or cloud mediated data sources. In addition, sources of local data (e.g. a hard drive, solid state drive, flash memory, or any other suitable memory, including dynamic memory, such as SRAM or DRAM) that can allow for local data storage of user-specified preferences or protocols.

Many modifications and other embodiments of the invention will come to the mind of one skilled in the art having the benefit of the teachings presented in the foregoing descriptions and the associated drawings. Therefore, it is understood that the invention is not to be limited to the specific embodiments disclosed, and that modifications and embodiments are intended to be included within the scope of the appended claims. It is also understood that other embodiments of this invention may be practiced in the absence of an element/step not specifically disclosed herein.

What is claimed is:

1. An apparatus comprising:
signal conversion electronics configured to convert received optical signals to an electrical signal;
an amplifier configured to convert the electrical signal to differential electrical signals and transmit the differential electrical signals to a sink;
a first conductor and a second conductor interfacing the amplifier with a sink side resistor network, the first conductor and the second conductor conducting a composite signal including the differential electrical signals and a first power signal from the sink side resistor network;
a filter connected to the first conductor and the second conductor and configured to:
receive the composite signal;
filter a second power signal from the composite signal that is at least a portion of the first power signal; and
a voltage regulator connecting the second power signal to the amplifier.

2. The apparatus of claim 1, wherein the resistive network is a part of an open drain interface interfacing the first conductor and the second conductor with a sink-side power supply.

3. The apparatus of claim 1, wherein the signal conversion electronics include one or more photodetectors.

4. The apparatus of claim 1, wherein the amplifier is a transimpedance amplifier.

5. The apparatus of claim 1, wherein the filter is comprised of one or more inductors.

6. The apparatus of claim 5, further comprising a first inductor connected to the first conductor and a second inductor connected to the second conductor.

7. The apparatus of claim 1, wherein the first power signal is a substantially time-invariant signal and the differential electrical signals are time-varying signals.

8. The apparatus of claim 1, further comprising a slew rate converter configured to limit a ramp-up rate of the second power signal.

9. The apparatus of claim 1, wherein the differential electrical signals are HDMI signals.

10. The apparatus of claim 1, wherein the optical signals are received over an optical communication channel.

11. The apparatus of claim 10, wherein the optical communication channel is comprised of one or more optical fibers.

12. A method comprising:
connecting a first power signal sourced from a sink to an amplifier;
converting received optical signals to an electrical signal;
converting the electrical signal to differential electrical signals;
transmitting the differential electrical signals to the sink;
conducting a composite signal including the differential electrical signals and the first power signal;
filtering a second power signal from the composite signal regulating the second power signal; and
connecting the regulated second power signal to the amplifier.

13. The method of claim 12, wherein converting the received optical signal to the electrical signal is performed by a photodetector.

14. The method of claim 12, wherein the amplifier is a transimpedance amplifier.

15. The method of claim 12, further comprising limiting a ramp-up rate of the second power signal.

16. The method of claim 15, wherein the limiting is performed by a slew rate converter.

17. The method of claim 12, wherein the first power signal is a substantially time-invariant signal and the differential electrical signals are time-varying signals.

18. The method of claim 12, wherein the differential electrical signals are HDMI signals.

19. The method of claim 12, wherein the optical signals are received over an optical communication channel.

20. The method of claim 12, wherein the optical communication channel is comprised of one or more optical fibers.
